(19) United States
(12) Patent Application Publication
(10) Pub. No.: US 2020/0152189 A1
(43) Pub. Date: May 14, 2020

(54) HUMAN RECOGNITION METHOD BASED ON DATA FUSION

(71) Applicant: SHUTTLE INC., Taipei City (TW)

(72) Inventor: Hsien-Lung KUO, Taipei City (TW)

(21) Appl. No.: 16/365,626

(22) Filed: Mar. 26, 2019

(30) Foreign Application Priority Data
Nov. 9, 2018 (TW) 107139897

(51) Int. Cl. G10L 15/22; G10L 15/26; G06K 9/62; G06K 9/00; G06F 17/27

(52) U.S. Cl. CPC G10L 15/22; G10L 15/26; G10L 2015/227; G06K 9/00221; G06F 17/2765; G06K 9/6289

(57) ABSTRACT

A human recognition method based on data fusion is provided. The human recognition system retrieves one of input voice and face image from a human, selects a part of a plurality of sample data according to the retrieved data, retrieves another of the input voice and the face image, and compares the retrieved another data with the selected sample data for recognizing the human. The present disclosed example can effectively reduce the probability of human recognition system being damaged, make the human pass the authentication without wearing any identification object, and shorten the time required for recognition.

### BACKGROUND OF THE INVENTION

### Field of the Invention

The technical field relates to human recognition and more particularly related to a human recognition method based on data fusion.

### Description of Related Art

The human recognition system of the related art is usually configured to capture an input feature (such as fingerprint or identifier stored in the RFID tag) of an unknown human, and compare the input feature of the unknown human with all of the samples (such as the fingerprint or identifier registered by the authorized humans in advance) stored in a database individually for recognizing whether the unknown human is one of the authorized humans. One of the disadvantages of the human recognition system of the related art is that the human recognition system must spend a long time in recognition for comparing the input feature of the unknown human with each sample individually if there are too many samples stored in the database. Above disadvantage makes the human recognition inefficient and user experience worse.

Besides, when a contact input device is used to accept a contact operation from the unknown human for sensing the input feature of the unknown human (for example, the human presses the human's finger for inputting fingerprint, or presses a keypad or inputting identifier), the contact input device often malfunctions and has a shorter service life because the contact input device is pressed frequently. Above status increases the maintenance cost of the human recognition system.

Besides, when a non-contact input device is used to accept a non-contact operation from the unknown human for inducting the input feature of the unknown human (for example, the human takes the human's RFID tag/Bluetooth device to approach the RFID reader/Bluetooth transceiver for inputting identifier stored in the RFID tag/Bluetooth device), because the human must extra carry the identification object (such as RFID tag or Bluetooth device), there is a problem of the human's identity being unable to be recognized when the human forgets about carrying the identification object.

Accordingly, there is currently a need for a schema of solving above-mentioned problems.

### SUMMARY OF THE INVENTION

The present disclosed example is directed to a human recognition method based on data fusion having an ability to use one type of input feature as an index to reduce the number of the samples to be compared and another type of input feature to confirm the human's identity according to the smaller number of the samples.

One of the exemplary embodiments, a human recognition method based on data fusion is disclosed, the method is applied to a human recognition system, the human recognition system comprises an image capture device and a voice-sensing device, and the method comprises steps of sensing a voice of a human by the voice-sensing device for generating an input voice; analyzing the input voice for generating an input text; selecting a part of a plurality of sample images according to the input text; shooting a face of the human by the image capture device for obtaining an input facial image; and comparing the input facial image with the selected part of the sample images for recognizing the human.

One of the exemplary embodiments, a human recognition method based on data fusion is disclosed, the method is applied to a human recognition system, the human recognition system comprises an image capture device and a voice-sensing device, and the method comprises steps of shooting a face of a human by the image capture device for obtaining an input facial image; selecting a part of a plurality of sample voice features according to the input facial image; sensing a voice of the human by the voice-sensing device for generating an input voice; analyzing the input voice for obtaining an input voice feature; and comparing the input voice feature with the selected part of the sample voice features for recognizing the human.

The present disclosed example can effectively reduce the probability of damage of human recognition system, make the human pass the identification without wearing any identification object, and shorten the time of recognition.

### BRIEF DESCRIPTION OF DRAWING

The features of the present disclosed example believed to be novel are set forth with particularity in the appended claims. The present disclosed example itself, however, may be best understood by reference to the following detailed description of the present disclosed example, which describes an exemplary embodiment of the present disclosed example, taken in conjunction with the accompanying drawings, in which:

FIG. 1 is an architecture diagram of a human recognition system according to a first embodiment of the present disclosed example;

FIG. 2 is a schematic view of a human recognition system according to a second embodiment of the present disclosed example;

FIG. 3 is a schematic view of a human recognition system according to a third embodiment of the present disclosed example;

FIG. 4 is a flowchart of a human recognition method according to a first embodiment of the present disclosed example;

FIG. 5 is a flowchart of a human recognition method according to a second embodiment of the present disclosed example;

FIG. 6 is a flowchart of a human recognition method according to a third embodiment of the present disclosed example;

FIG. 7 is a flowchart of a voice comparison process according to a fourth embodiment of the present disclosed example;

FIG. 8 is a flowchart of an image comparison process according to a fifth embodiment of the present disclosed example;

FIG. 9 is a flowchart of computing a similarity according to a sixth embodiment of the present disclosed example;

FIG. 10 is a flowchart of configuring sample images according to a seventh embodiment of the present disclosed example; and

FIG. 11 is a flowchart of a human recognition method according to an eighth embodiment of the present disclosed example.

### DETAILED DESCRIPTION OF THE INVENTION

In cooperation with attached drawings, the technical contents and detailed description of the present disclosed example are described thereinafter according to a preferable embodiment, being not used to limit its executing scope. Any equivalent variation and modification made according to appended claims is all covered by the claims claimed by the present disclosed example.

The present disclosed example discloses a human recognition system based on data fusion (hereinafter the human recognition system for abbreviation), and the human recognition system is used to execute a human recognition method based on data fusion (hereinafter the human recognition method for abbreviation). The present disclosed example may retrieve the first type of input feature (such as one of voice and facial image) of a human, and configure the first type of input feature as an index to filter out a part of a plurality of sample data for reducing the number of sample data to be compared. Then, the present disclosed example may retrieve the second type of input feature (such as another one of voice and facial image), and compare the second type of input feature with the filtered sample data for recognizing the identity of the human.

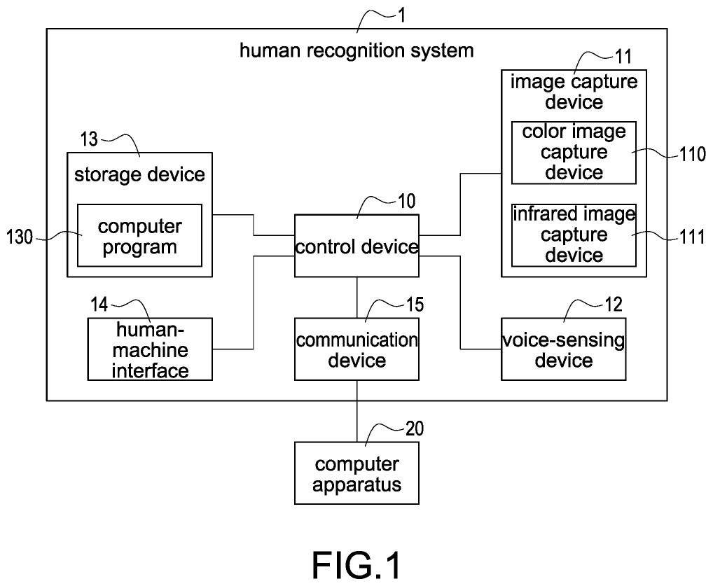

Please refer to FIG. 1, which is an architecture diagram of a human recognition system according to a first embodiment of the present disclosed example. The human recognition system 1 of the present disclosed example mainly comprises an image capture device 11 (such as a camera), a voice-sensing device 12 (such as a microphone), a storage device 13 and a control device 10 (such as a processor or a control host) electrically connected (such as connecting by transmission cable, internal cable or network) to above devices.

The image capture device 11 is used to shoot each human and generate the facial image (hereinafter referred to as the input facial image) of the human, and the type of the input facial image is electronic data. The voice-sensing device 12 is used to sense the voice of each human and transfer the sensed voice into the voice with a type of electronic data (hereinafter referred to as the input voice).

The storage device 13 is used to store data. More specifically, the storage device 13 is stored a plurality of sample data (such as the sample image, sample voice feature and/or sample text described later). The control device 15 is used to control the human recognition system 1.

One of the exemplary embodiments, the image capture device 11 comprises at least one color image capture device 110 (such as the RGB color camera) and at least one infrared image capture device 111 (such as a camera installed an infrared filter or a camera without ICF (Infrared Cut Filter), the infrared filter is used to filtering out the visible light and make the infrared light transparent, and the ICF is used to filter out the infrared light).

The color image capture device 110 is used to sense the environmental visible light and generate the corresponding color image, namely, the color image capture device 110 may be used to shoot the color facial image of the human.

The infrared image capture device 111 is used to sense the environmental infrared ray and generate the corresponding infrared image (in general, the infrared image is a gray-scale image), namely, the infrared image capture device 111 may be used to shoot the infrared facial image of the human.

One of the exemplary embodiments, the human recognition system 1 may comprise a human-machine interface 14 (such as keyboard, mouse, display, touch screen or any arbitrary combination of the input devices and/or the output devices) electrically connected to the control device 10. The human-machine interface 14 is used to receive the human's operation and generate the corresponding data.

One of the exemplary embodiments, the human recognition system 1 may comprise a communication device 15 (such as USB module, Ethernet module or the other wired communication modules, Wi-Fi module, Bluetooth module or the other wireless module, gateway, route and so on) electrically connected to the control device 10. The communication device 15 is used to connect to the external computer apparatus 20.

One of the exemplary embodiments, the storage device 13 may comprise the database (not shown in figure), and the database is used to store above-mentioned sample data, but this specific example is not intended to limit the scope of the present disclosed example.

One of the exemplary embodiments, the database may be stored in the external computer apparatus 20, and the human recognition system 1 is configured to receive above-mentioned sample data from the computer apparatus 20 by the communication device 15.

One of the exemplary embodiments, the storage device 13 comprises a non-transient computer readable recording media, and a computer program 130 is recorded in the non-transient computer readable recording media. A plurality of computer readable codes are recorded in the computer program 130. The control device 10 may control the human recognition system 1 to implement each step of the human recognizing method of the present disclosed example by execution of the computer-executable codes.

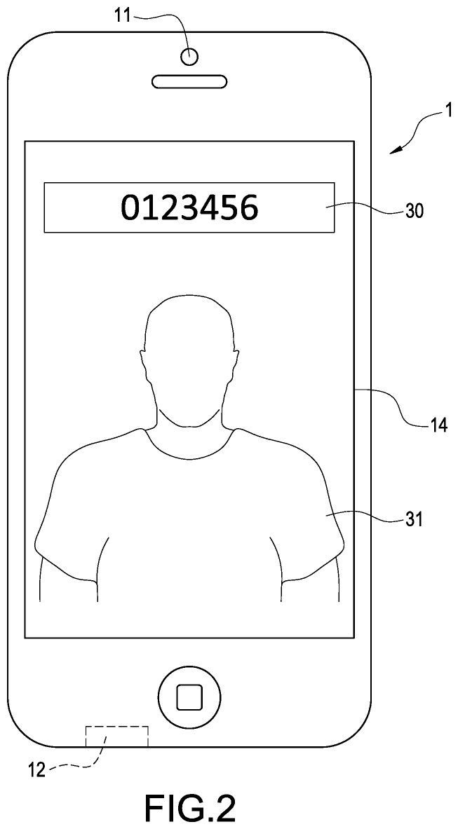

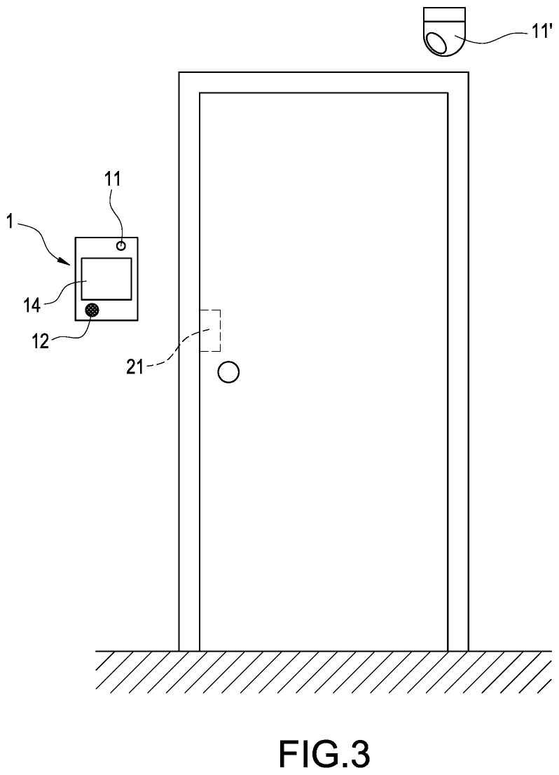

Please be noted that each device of the human recognition system 1 may be installed in the same apparatus in an integration way (such as being installed in the mobile device in the integration way as shown in FIG. 2, or being installed in the door phone in the integration way as shown in FIG. 3), or be installed at the different positions (such as the image capture device 11 and the door phone are installed in at the different positions separately as shown in FIG. 3), but this specific example is not intended to limit the scope of the present disclosed example.

Please refer to FIG. 2, which is a schematic view of a human recognition system according to a second embodiment of the present disclosed example. In this embodiment, the human recognition system 1 may be a mobile device (take a smartphone for example in FIG. 2), and the computer program 130 may be an application program (APP) compatible with this mobile device. The image capture device 11, the voice-sensing device 12 and the human-machine interface 14 (take touchscreen for example in this embodiment) are arranged on the mobile device.

Please refer to FIG. 3, which is a schematic view of a human recognition system according to a third embodiment of the present disclosed example. In this embodiment, the human recognition system 1 may be an access control system (take the access control system comprising a door phone and door lock 21) which is installed at a fixed installation position, and the computer program 130 may be an application program (APP), an operating system or a firmware compatible with this access control system. The image capture device 11, the voice-sensing device 12 and the human-machine interface 14 (take touchscreen for example in this embodiment) are arranged on the door phone.

The access control system may automatically unlock the door lock 21 to make the human be unable to access to the control area when recognizing that the human is the registered human by the human recognition method of the present disclosed example, so as to achieve the function of access control.

One of the exemplary embodiments, the image capture device and the door phone are installed at the different positions separately (such as the image capture device 11′ is installed at the high position on the wall). Thus, the image capture device 11′ may get the wider capture view, and deduce the probability of being destroyed.

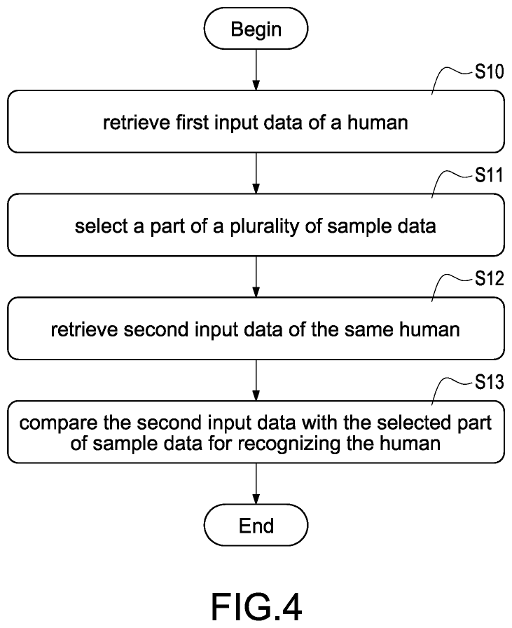

Please refer to FIG. 4, which is a flowchart of a human recognition method according to a first embodiment of the present disclosed example. The human recognition method of each embodiment of the present disclosed example may be implemented by anyone of the human recognition system 1 shown in FIGS. 1-3. The human recognition method of this embodiment mainly comprises following steps.

Step S10: the control device 10 retrieves first input data of the human.

For example, the control device 10 shoots the human by the image capture device 11 for obtaining one or more input image(s) as the first input data (such as the facial image(s), the gesture image(s) or the other image(s) for recognition of the human).

One example, the control device 10 senses the voice of the human by the voice-sensing device 12 for obtaining the input voice as the first voice data (such as the text corresponding to the input voice or the voiceprint).

Step S11: the control device 10 selects a part of a plurality of the sample data according to the first input data. More specifically, the database may be configured to store a plurality of sample data, the plurality of sample data respectively corresponds to the different humans. Moreover, each sample data may comprise the first sample data with the same data type as the first input data (such as one of the images and voices) and the second sample data with the same data type as the second input data (such as another of the image and voice).

Please be noted that abovementioned first sample data is used as an index for grouping a large amount of sample data. Namely, all or part of the first sample data of each sample data may be different from each other.

For example, if there are one hundred sample data, the first sample data of each sample data may be different from each other. Namely, one hundred sample data may be divided into one hundred groups. In another example, if fifty sample data are the same as each other, the other fifty sample data are the same as each other. Namely, one hundred sample data may be divided into two groups.

Moreover, above-mentioned second sample data is used to recognize and verify the identity of the human. To achieve this objective, the second sample data of each sample is configured to be different from each other. Namely, one hundred sample data comprise one hundred types of second sample data.

In the step S11, the control device 10 compares the obtained first input data with the first sample data of each sample data to determine one or more sample data which its first sample data matches with the first input data, and selects the matched one or more sample data from the plurality of sample data.

Step S12: the control device 10 retrieves the second input data of the human. More specifically, if the control device 10 is configured to retrieve the input image as the first input data in the step S10, the control device 10 is configured to sense the voice of the human by the voice-sensing device 12 in the step S12 for obtaining the input voice as the second input data.

Vice versa, if the control device 10 is configured to retrieve the input voice as the first input data in the step S10, the control device 10 is configured to shoot the human by the image capture device 11 in the step S12 for obtaining input image as the second input data.

Step S13: the control device 10 compares the second input data with the selected sample data. More specifically, the control device 10 compares the second input data with the second sample data of each selected sample data.

If the second input data matches with the second sample data of any selected sample data, the control device 10 recognizes that the current human is an authorized human. Namely, the current human passes the authentication.

One of the exemplary embodiments, the human recognition system 1 may further determine the identity of the current human. More specifically, a plurality of sample data respectively corresponds to the human identity data of the different humans. The control device 10 is configured to make the human identity data corresponding to the matched sample data as the identity of the current human.

The present disclosed example can effectively reduce the amount of sample data to be compared by using the first input data to filter, and increase the recognition speed.

Moreover, the present disclosed example makes humans be not necessary to carry the additional identification object by using the image and voice of the human as the input feature, and improve the user experience.

Moreover, the image capture device and the voice-sensing device used by the present disclosed example have a longer service life because of capturing the input feature in a contactless manner, and the present disclosed example can reduce the cost of maintaining the devices.

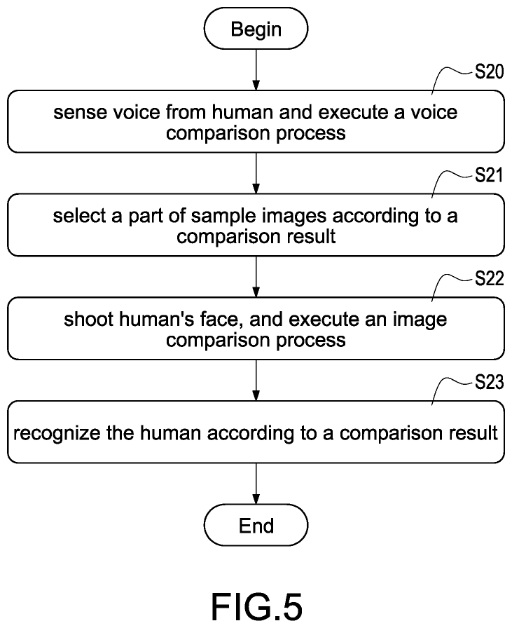

Please refer to FIG. 5, which is a flowchart of a human recognition method according to a second embodiment of the present disclosed example. The human recognition method of this embodiment is configured to select a part of sample images (namely the above-mentioned second sample data of sample data) according to a semantic content (namely text, such as the word(s), sentence(s) or any combination of both spoken by the human) of an input voice (namely the above-mentioned first input data) of the human, and compare the input facial image (namely the above-mentioned second input data) of the human with the select part of the sample images for recognizing the identity of the human. More specifically, the human recognition method of this embodiment comprises the following steps.

Step S20: the control device 10 senses voice of a human by the voice-sensing device 12 for generating the input voice, and executes a voice comparison process on the input voice.

One of the exemplary embodiments, each sample data comprises a sample text and a sample image (namely, the sample texts respectively correspond to the sample images), and the above-mentioned voice comparison process is a text comparison process to compare the text corresponding to the input voice with pre-stored text. More specifically, the human may speak a text to the voice-sensing device 12 (such as the department, name, identity codes and so on of the human), the control device 10 may capture the voice of the human by the voice-sensing device 12 as the input voice, and execute an analysis (such as execution of a voice-text analysis process) on the input voice for obtaining the input text corresponding to the text spoken by the human. Then, the control device 10 compares the input text with each sample text individually, and selects the sample data which its sample text matches with the input text as the comparison result.

Furthermore, one of the exemplary embodiments, as shown in FIG. 2, the control device 10 may display the input text 30 obtained by analysis on the human-machine interface 14 for making the human understand whether the input text obtained by analyzing the input voice meets the human's expectation. Namely, the human has an ability to determine whether the input text spoken by the human is consistent with the input text analyzed by the control device 10.

One of the exemplary embodiments, each sample data comprises a sample voiceprint and a sample image (namely, the sample voiceprints respectively correspond to the sample images), and the above-mentioned voice comparison process is a voiceprint comparison process for comparing the input voiceprint with each sample voiceprint. More specifically, the human may speak any word to the voice-sensing device 12, the control device 10 may execute analysis on the input voice spoken by the human (such as execution of a voiceprint analysis process) for obtaining the input voiceprint, Then, the control device 10 compares the input voiceprint with each sample voiceprint individually, and selects the sample data which its sample voiceprint matches with the input voiceprint as the comparison result.

Moreover, if the input voiceprint doesn't match with all of the sample voiceprints or the input text doesn't match with all of the sample texts, the control device 1 may be configured to select no sample data.

Step S21: the control device 10 selects part of the sample images according to the comparison result.

One of the exemplary embodiments, each sample data comprises the sample text and the sample image. The control device 10 is configured to determine the part of the sample data which its/their sample text(s) matches with the input text, and select each sample image of the matched sample data.

One of the exemplary embodiments, each sample data comprises a sample voiceprint and a sample image. The control device 10 is configured to determine a part of the sample data which its/their sample voiceprint(s) matches with the input voiceprint, and select each sample data of the matched sample data.

One of the exemplary embodiments, if the control device 10 determines that the current human doesn't match with all of the sample data (for example, there is not any sample data being selected in the step S20), the control device 10 may issue a warning by the human-machine interface 14.

Step S22: the control device 10 captures face of the human by the image capture device 11 for obtaining a facial image, and executes an image comparison process on the input facial image according to the selected part of sample image(s). More specifically, the control device 10 compares the input facial image with each of the selected sample image(s) individually, and selects the matched sample image as the comparison result.

One of the exemplary embodiments, the control device 10 is configured to compute a similarity between the input facial image and each selected sample image individually, and selects the sample image which its similarity is highest and not less than a similarity threshold as the comparison result. Moreover, if all of the similarities between the input facial image and each sample image are less than the similarity threshold, the control device 10 doesn't select any sample image.

Furthermore, one of the exemplary embodiments, as shown in FIG. 2, the control device 10 may control the human-machine interface 14 to displays the captured input facial image 31 for making the human understand whether the capture facial image 31 meets the human's expectation. Namely, the human has an ability to determine whether the input facial image 31 retrieved by the control device 10 shows the human's facial appearance correctly and clearly.

Step S23: the control device 10 recognizes the human according to the comparison result. More specifically, if the control device 10 determines that the human matches with any sample image (for example, there is any sample image being selected in the step S22), the control device 10 recognizes that the current human is the authorized/registered human.

If the control device 10 determines that the human doesn't match with all of the sample images (for example, there is not any sample image being selected in the step S22), the control device 10 determines that the human is the unauthorized/unregistered human.

One of the exemplary embodiments, the human recognition system 1 may further determine the identity of the current human. More specifically, the sample images respectively correspond to a plurality of human identity data of the different humans. The control device 10 is configured to take the human identity data corresponding to the matched sample image as the identity of the current human.

Please be noted that because the speed of comparison of texts is far faster than the speed of comparison of voiceprint, when selecting a part of a plurality of sample data according to the input text, the present disclosed example can drastically reduce the time required for comparison, and reduce the time for recognizing the human.

Furthermore, if each text is not the same as the other sample texts, the present disclosed example can drastically the number of the sample images to be compared in the following process, and drastically increase the accuracy and the comparison speed of the following image comparison.

Moreover, because the voiceprint is unique, when selecting a part of sample data according to the input voiceprint, the present disclosed example can drastically reduce the number of sample images to be compared in the following process via filtering the unmatchable voiceprints out in advance, and drastically increase the accuracy and the comparison speed of the following image comparison.

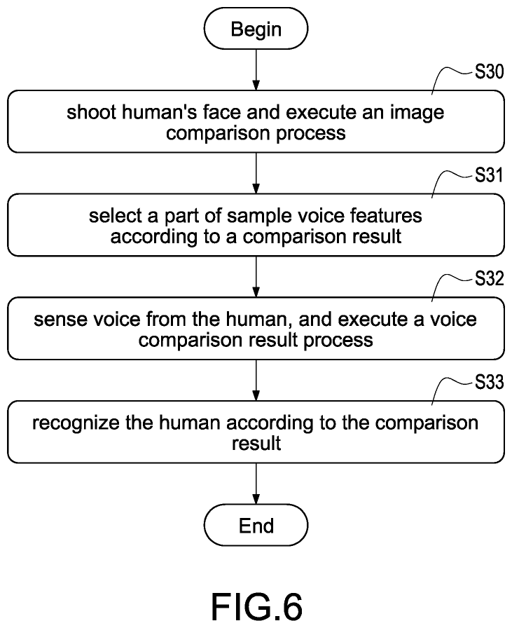

Please refer to FIG. 6, which is a flowchart of a human recognition method according to a third embodiment of the present disclosed example. The human recognition method of this embodiment is configured to select a part of sample voice features (namely the above-mentioned sample data) according to the input facial image of the human (namely the above-mentioned first input data) of the human, and compare the input voice (namely the above-mentioned second input data) of the human with the select part of the sample voice features for recognizing the identity of the human. More specifically, the human recognition method of this embodiment comprises following steps.

Step S30: the control device 10 shoots the face of the human by the image capture device 11 for obtaining the input facial image, and executes an image comparison process on the input facial image according to the selected part of sample images. The image comparison process of step S30 may be the same or similar as the image comparison process of step S22, the relevant description is omitted for brevity.

More specifically, each sample data comprises one or more sample voice feature(s) (such as the sample text(s) or the sample voiceprint(s)) and one or more sample image(s). Namely, the sample voice features of the plurality of sample data respectively correspond to the sample images of the plurality of sample data. The control device 10 is configured to compare the input facial image with each sample image, and select the matched sample image (such as the sample image which its similarity is not less the similarity threshold, above similarity threshold may less than the similarity threshold of the step S22 shown in FIG. 5) as the comparison result.

Moreover, if the input facial image doesn't match with any of all the sample images, the control device 10 doesn't select any sample data.

Step S31: the control device 10 selects a part of a plurality of sample voice features according to the comparison result.

One of the exemplary embodiments, each sample data comprises one or more sample voice feature(s) and one or more sample image(s). The control device 10 is configured to determine the part of the sample data comprising the matched sample image, and selects the sample voice features of the matched sample data.

One of the exemplary embodiments, if the control device 10 determines that all of sample data are not matched (for example, there is not any sample data selected in step S30), the control device 10 issues a warning by the human-machine interface 14.

Step S32: the control device 10 receives the voice of the human by the voice-sensing device 12 for generating the input voice, and execute the voice comparison process on the input voice according to the selected part of the sample voice features. The voice comparison process of step S32 may be the same or similar as the voice comparison process of step S20, the relevant description is omitted for brevity.

One of the exemplary embodiments, each sample data comprises one or more sample voice feature(s) and one or more sample image(s). More specifically, the human may speak any (designated) word to the voice-sensing device 12, the control device 10 may execute analysis on the input voice spoken by the human for obtaining the input voice feature (such as voiceprint or input text). Then, the control device 10 compares the input voice feature with each sample voice feature individually, and selects the sample data comprising the sample voice feature most matching with the input voice feature as the comparison result.

Moreover, if the input voice feature doesn't match with all the sample voice features, the control device 10 doesn't select any sample data.

Step S33: the control device 10 recognizes the human according to the comparison result. More specifically, if the control device 10 determines that the human's voice matches with any sample voice feature (for example, there is any sample voice feature selected in the step S32), the control device 10 recognizes that the current human is the authorized/registered human. If the control device 10 determines that the human's voice doesn't match with all of the sample voice feature (for example, there is not any sample voice feature being selected in the step S32), the control device 10 determines that the human is the unauthorized/unregistered human.

One of the exemplary embodiments, the human recognition system 1 may further determine the identity of the current human. More specifically, a plurality of sample voice feature respectively of a plurality of sample data respectively correspond to the human identity data of the different humans. The control device 10 is configured to make the human identity data corresponding to the matched sample voice feature of the sample data as the identity of the current human.

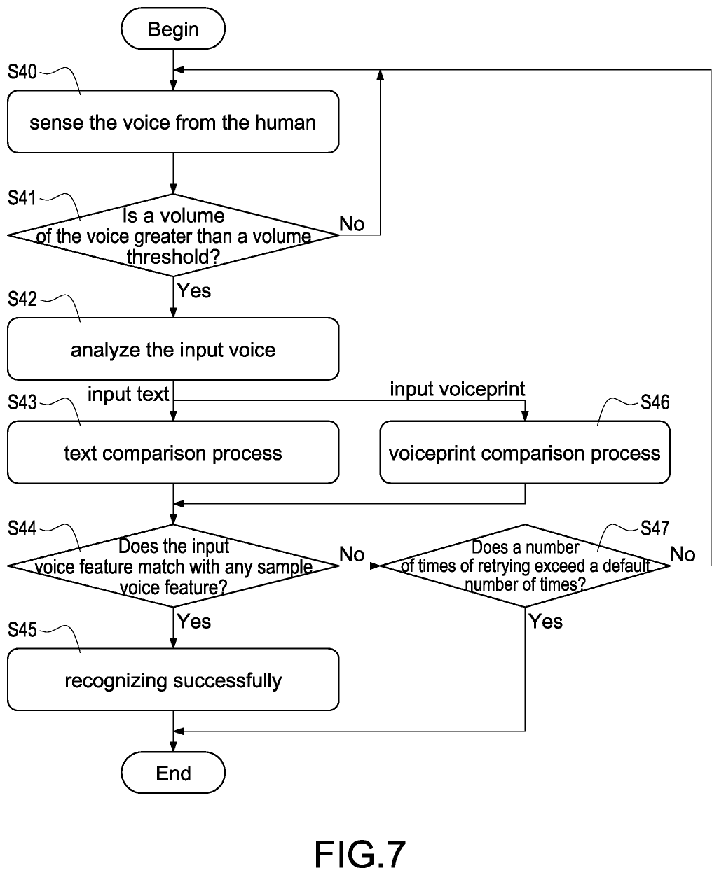

Please refer to FIG. 7, which is a flowchart of a voice comparison process according to a fourth embodiment of the present disclosed example. This embodiment discloses a specific implement schema of the voice comparison process, the schema may be applied to any of the human recognition method shown in FIGS. 4-7. For example, the schema may be applied to the voice comparison process in step S20 of FIG. 5 or the voice comparison process in step S32 of FIG. 6. More specifically, the voice comparison process of this embodiment comprises following steps for achieving the function of voice comparison.

Step S40: the control device 10 senses environmental voice by the voice-sensing device 12 for generating the input voice, and executes a voice comparison process on the input voice.

Step S41: the control device 10 determines whether a volume of the input voice is greater than a volume threshold.

If the volume of the input voice is greater than the volume threshold, the control device 10 determines that the generated input voice comprises a voice of the human, and executes the step S42. Otherwise, the control device 10 determines that the generated input voice doesn't comprise any voice of human, and executes the step S40 again.

Step S42: the control device 10 executes an analysis process on the input voice, such as a text analysis process (executing step S43) or a voiceprint analysis process (executing step S46).

If the control device 10 executes the text analysis process and obtains the input text, the control device 10 then performs a step S43: the control device 10 executing above-mentioned text comparison process on the input text and the sample texts of a plurality of the sample data for selecting the sample data comprising the matched sample text.

If the control device 10 executes the voiceprint analysis process and obtains the input voiceprint, the control device 10 performs a step S46: the control device 10 executing above-mentioned voiceprint comparison process on the input voiceprint and the sample voiceprints of a plurality of sample data for selecting the sample data comprising the matched sample voiceprint.

Step S44: the control device 10 determines whether the input voice feature (such as the input text or the input voiceprint) matches with any sample voice feature, such as determining whether there is any sample data selected in the step S43 or S46.

If the input voice feature matches with any sample voice feature, the control device 10 performs a step S45. If the input voice feature doesn't match with all sample voice features, the control device 10 performs a step S47.

Step S45: the control device 10 determines that recognition is successful.

One of the exemplary embodiments, the control device 10 simultaneously executes the text analysis process and the voiceprint analysis process on the input voice, determines that the recognition is successful when the input text matches with any sample text of one sample data and the input voiceprint matches with the sample voiceprint of the same sample data, and takes the human identity data corresponding to this matched sample data as the identity of the human.

Step S47: the control device 10 determines the comparison result generated by this voice comparison process is failure in recognition, and counts a number of re-executions of the voice comparison process caused by the failure in recognition (such as the continuous failures). Then, the control device 10 determines whether above-mentioned number of re-executions exceeds a default number (such as three times).

If the number of re-executions exceeds the default number, the control device 10 doesn't re-execute the voice comparison process for preventing the people with bad intention from cracking the human recognition system 1 by a manner of brute force.

If the number of re-executions doesn't exceed the default number, the control device 10 re-senses the input voice of the same human by the voice-sensing device 12 (step S40) for re-execution of the voice comparison process.

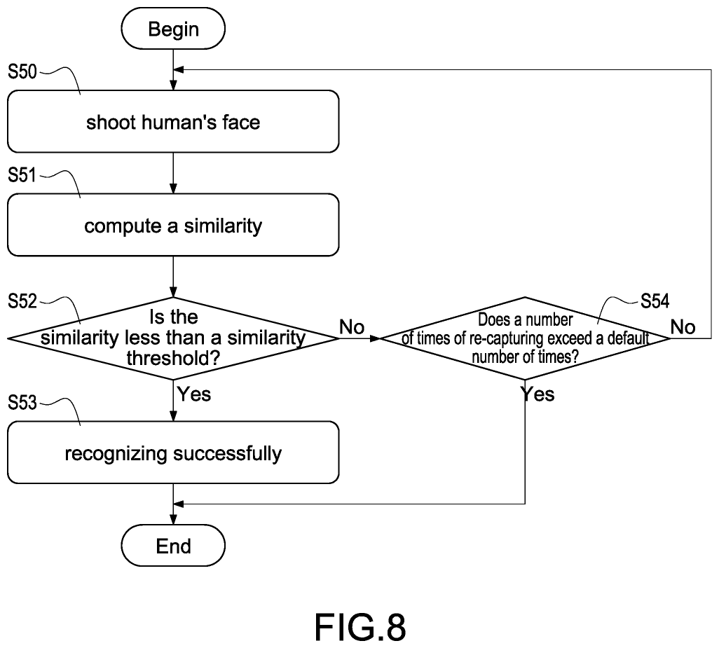

Please refer to FIG. 8, which is a flowchart of an image comparison process according to a fifth embodiment of the present disclosed example. This embodiment discloses a specific implement schema of the image comparison process, the schema may be applied to any of the human recognition method shown in FIGS. 4-7. For example, the schema may be applied to the image comparison process in step S22 of FIG. 5 or the image comparison process in step S30 of FIG. 6. More specifically, the voice comparison process of this embodiment comprises following steps for achieving the function of image comparison.

Step S50: the control device 10 capture the face of the human for obtaining the input facial image by the image capture device 11.

One of the exemplary embodiments, the control device 10 is configured to control the image capture device 11 to capture the face of the human many times to obtain a plurality of facial images of the same human.

Step S51: the control device 10 computes the similarities between the input facial images and the sample image(s) of each sample data.

One of the exemplary embodiments, each sample data may comprise one or more sample image(s), the control device 10 compares each of (one or more) input facial image(s) with each sample image of the same sample data (such as comparing their pixel values or image features) for determining the similarity between each sample image and each input facial image.

Step S52: the control device 10 determines whether any similarity is not less than the similarity threshold.

If the control device 10 determines that the similarity to any input facial image is not less than the similarity threshold, the control device 10 performs a step S53.

If the control device 10 determines that the similarities of all of the input facial images are less than the similarity threshold, the control device 10 performs a step S54.

One of the exemplary embodiments, the control device 10 is configured to performs the step S53 when all or half of the similarities of the input facial images are not less than the similarity threshold.

Step S52: the control device 10 determines that recognition is successful.

Step S54: the control device 10 determines the comparison result generated by this image comparison process is failure in recognition, and counts a number of re-executions of the image comparison process caused by the failure in recognition (such as the continuous failures). Then, the control device 10 determines whether above-mentioned number of re-executions exceeds a default number (such as three times).

If the number of re-executions exceeds the default number, the control device 10 doesn't re-execute the image comparison process for preventing the people with bad intention from cracking the human recognition system 1 by a manner of brute force.

If the number of re-executions doesn't exceed the default number, the control device 10 re-captures the input facial images of the same human by the image capture device 11 (step S50) for re-execution of the image comparison process.

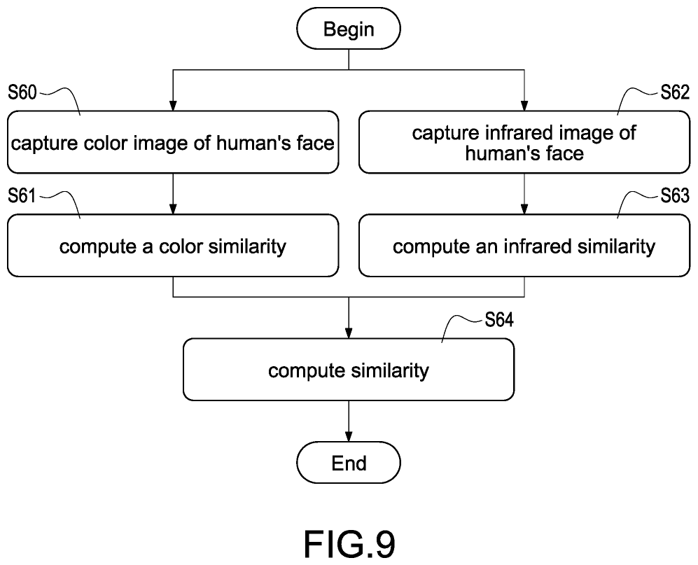

Please refer to FIG. 8 and FIG. 9. FIG. 9 is a flowchart of computing a similarity according to a sixth embodiment of the present disclosed example. This embodiment discloses a specific implement schema of computing the similarity, the schema may be applied to the similarity computation shown in FIG. 8 (such as being applied to the steps S50-S51 of FIG. 8).

More specifically, in this embodiment, the image capture device 11 comprises a color image capture device 110 and an infrared image capture device 111. Each sample image comprises one or more color sample image and one or more infrared sample image. This embodiment mainly discloses that determining the final similarity according to the color similarity between the color images and the infrared similarity between the infrared images. Namely, this embodiment is to recognize the human via comparing the color facial image with the color sample image and comparing the infrared facial image with the infrared sample image.

The similarity computation of this embodiment comprises following steps.

Step S60: the control device 10 shoots face of the human by the color image capture device 110 for obtaining one or more color facial image(s).

Step S61: the control device 10 executes image comparison process on the captured color facials image(s) and the color sample image(s) of each sample image for determines the color similarity between each color facial image and each color sample image.

Step S62: the control device 10 captures face of the human by the infrared image capture device 111 for obtaining one or more infrared facial image.

Step S63: the control device 10 executes image comparison process on the captured infrared facials image(s) and the infrared sample image(s) of each sample image for determines the infrared similarity between each infrared facial image and each infrared sample image.

Step S64: the control device 10 computes the similarity to each sample image according to the color similarity and the infrared similarity to the same sample image. Please be noted that because of the color image comparison process has a higher false rate when the color temperature of environmental lighting changes, the present disclosed example can effectively prevent the color image comparison process from the false determination caused by variation of the color temperature of environmental lighting via combining the infrared comparison process (for thermal radiation image of the environment), and increase accuracy rate.

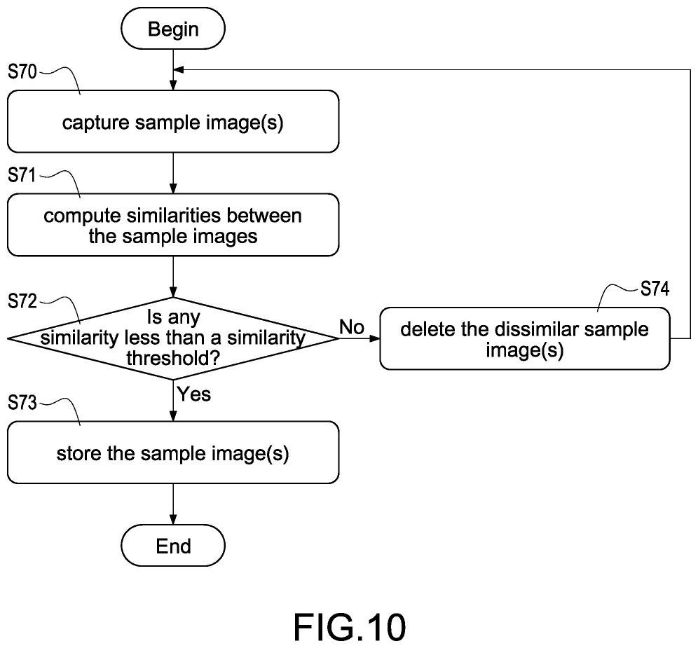

Please refer to FIG. 8 and FIG. 10. FIG. 10 is a flowchart of configuring sample images according to a seventh embodiment of the present disclosed example. This embodiment is used to provide a function of configuring the sample images having the ability to establish the sample images of the registered humans, the established sample images are applied to above-mentioned image comparison process. More specifically, the human recognition method of this embodiment comprises following steps for achieving the function of configuring the sample images before human recognition.

Step S70: the control device 10 captures a plurality of sample images of the same human by the image capture device 11, such as capturing five sample images of the same human.

One of the exemplary embodiments, the control device 10 may control the color image capture device 110 to capture one or more color sample images of the same human, and control the infrared image capture device 111 to capture one or more infrared image of the same human.

Step S71: the control device 10 computes the similarity between the sample images, such as computing the similarity according to the color similarity and infrared similarity.

Step S72: the control device 10 determines whether the similarities between each of the sample images and the other images are not less than a default similarity threshold.

If all of the similarities of the sample images are not less than the similarity threshold, the control device 10 performs a step S73.

If any of the similarities of the sample images us not less than the similarity threshold, the control device 10 performs a step S74.

Step S73: the control device 10 stores all the sample images matching with each other, and completes the configuration of one group of sample images.

Step S74: the control device 10 deletes the sample image which the similarity between the sample image and any of the other sample images is less than the similarity threshold, performs the step S70 again for re-capturing the new sample image for replacing the deleted and dissimilar sample image, and continue to configure the sample image.

For example, the control device 10 controls the image capture device 11 to capture three sample images (called the first sample image, the second image, and the third sample image), the similarity threshold is 95%. The similarity between the first sample image and the second sample image is 80%, the similarity between the first sample image and the third sample image is 75%, and the similarity between the second sample image and the third sample image is 98%

This shows that the first sample image is dissimilar with the other sample images (their similarity is less than 95%). The human recognition system 1 may delete the first sample image and re-capture the new sample image (called the fourth sample image), and computes the similarities between the fourth sample image, the second sample image, and the third sample image, and so on.

The present disclosed example can make the configured sample images be very similar with each other, and effectively increase the accuracy rate of image comparison.

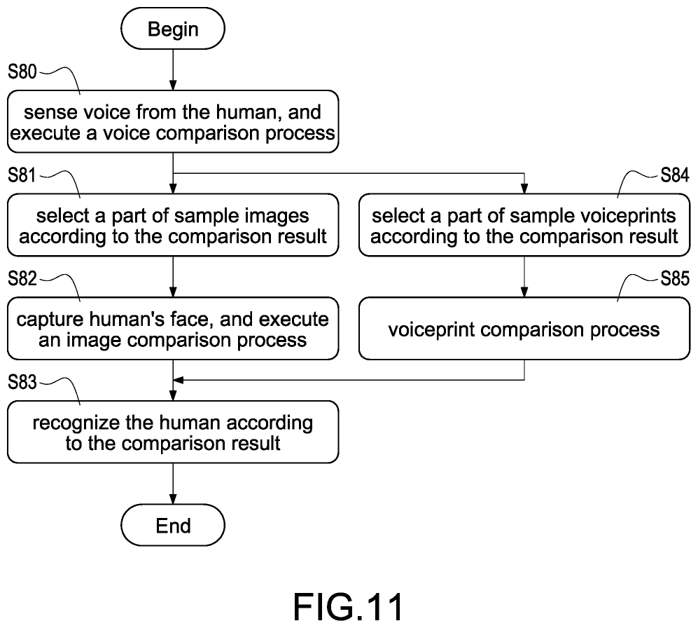

Please refer to FIG. 5 and FIG. 11. FIG. 11 is a flowchart of a human recognition method according to an eighth embodiment of the present disclosed example. Compare to the human recognition method shown in FIG. 5, the human recognition method of this embodiment may selectively execute the image comparison process and the voiceprint comparison process for recognizing the identity of the human, such as only the image comparison process being executed, only the voiceprint comparison process being executed, or both the image comparison process and the voiceprint comparison process being executed. Moreover, in this embodiment, each sample data comprises a sample text, a sample voiceprint and a sample image, and the plurality of the sample data respectively correspond to a plurality of human identity data of the different humans. More specifically, the human recognition method of this embodiment comprises following steps.

Step S80: the control device 10 receives voice of the human by the voice-sensing device 12 for generating the input voice, and executes the voice comparison process on the input voice (such as above-mentioned text analysis process and text comparison process).

Then, the control device 10 may execute the image comparison process of step S81 and S82.

Step S81: the control device 10 determines the part of the sample data comprising the input text matching with the input text, and selects the sample image of the matched sample data.

Step S82: the control device 10 shoots face of the human by the image capture device 11 for obtaining the input facial image, and executes the image comparison process on the input facial image according to the selected part of the sample image(s).

Moreover, the control device 10 may further perform the voiceprint comparison process of step S84 and S85.

Step S84: the control device 10 determines the part of sample data comprising the sample text matching with the input text, and selects the sample voiceprint of the matched sample data.

Step S85: the control device 10 analyzes the input voice for obtaining the input voiceprint, and executes the voiceprint comparison process on the input voiceprint according to the selected part of the sample voiceprint.

Step S83: the control device 10 recognizes the human according to the comparison result of the image comparison process and/or the comparison result of the voiceprint comparison process.

One of the exemplary embodiments, the control device 10 is configured to configure the human identity data corresponding to the matched sample image determined in the image comparison process as the identity of the current human.

One of the exemplary embodiments, the control device 10 is configured to configure the human identity data corresponding to the matched sample voiceprint determined in the voiceprint comparison process as the identity of the current human.

One of the exemplary embodiments, when the human identity data corresponding to the matched sample image determined in the image comparison process is the same as the human identity data corresponding to the matched sample voiceprint determined in the voiceprint comparison process, the control device 10 configures this repeated identify data as the identity of the current human.

The present disclosed example can effectively improve the accuracy rate of human recognition via combining the image comparison process and the voiceprint comparison process.

The above-mentioned are only preferred specific examples in the present disclosed example, and are not thence restrictive to the scope of claims of the present disclosed example. Therefore, those who apply equivalent changes incorporating contents from the present disclosed example are included in the scope of this application, as stated herein.

What is claimed is:

1. A human recognition method based on data fusion, the method being applied to a human recognition system, the human recognition system comprising an image capture device and a voice-sensing device, the method comprising following steps:
a) sensing voice of a human by the voice-sensing device for generating input voice;
b) analyzing the input voice for generating an input text;
c) selecting a part of a plurality of sample images according to the input text;
d) capturing face of the human by the image capture device for obtaining an input facial image; and
e) comparing the input facial image with the selected part of the sample images for recognizing the human.

2. The human recognition method based on data fusion according to claim 1, wherein the step b) is performed to analyze the input voice for obtaining the input text when a volume of the sensed voice is greater than a volume threshold.

3. The human recognition method based on data fusion according to claim 1, wherein the step c) comprises following steps:
c1) comparing the input text with a plurality of sample texts, wherein the sample texts correspond to the sample images respectively; and
c2) when the input text matches with any sample text, selecting the sample image corresponding to the matched sample text.

4. The human recognition method based on data fusion according to claim 1, wherein the sample images correspond to a plurality of human identity data respectively; the step e) is performed to configure the human identity data corresponding to the matched sample image as an identity of the human when the input facial image matches with any of the selected part of the sample images.

5. The human recognition method based on data fusion according to claim 4, wherein the image capture device comprises a color image capture device and an infrared image capture device; each sample image comprises a color sample image and an infrared sample image; the step d) comprises following steps:
d1) capturing the face of the human by the color image capture device for obtaining a color facial image; and
d2) capturing the face of the human by the infrared image capture device for obtaining an infrared facial image;
the step e) is performed to compare the color facial image with the selected part of the color sample images, and compare the infrared facial image with the selected part of the infrared sample images for recognizing the human.

6. The human recognition method based on data fusion according to claim 5, wherein the step e) comprises following steps:
e1) comparing the color facial image with each color sample image selected in the step c) for determining a color similarity between the color facial image and each color sample image;
e2) comparing the infrared facial image with each infrared sample image selected in the step c) for determining an infrared similarity between the infrared facial image and each infrared sample image;
e3) computing a similarity to each sample image according to the color similarity and the infrared similarity to each sample image; and
e4) when any similarity to the sample image is not less than a similarity threshold, configuring the human identity data corresponding to the sample image as the identity of the human.

7. The human recognition method based on data fusion according to claim 4, wherein each human identity data corresponds to the sample images respectively; the step e) comprises following steps:
e5) comparing the input facial image with the sample images selected in the step c) individually for determining each similarity between the input facial image and each sample image;
e6) when any similarity to the sample image is not less than a similarity threshold, configuring the human identity data corresponding to the sample image as the identity of the human; and
e7) the step d) is performed when the similarities to all of the sample images are less than the similarity threshold.

8. The human recognition method based on data fusion according to claim 7, wherein the step d) is performed to obtain the input facial images of the same human; the step e5) is performed to compare each input facial image with each sample image selected in step c) individually for determining the similarity between each input facial image and each sample image.

9. The human recognition method based on data fusion according to claim 1, further comprising following steps:
f1) selecting a part of a plurality of sample voiceprints according to the input text;
f2) analyzing the input voice for obtaining an input voice; and
f3) comparing the input voiceprint with each selected sample voiceprint for recognizing the human.

10. The human recognition method based on data fusion according to claim 9, wherein the sample images respectively correspond to a plurality of human identity data, the sample voiceprints respectively correspond to the plurality of human identity data; the step e) is performed to select the human identity data corresponding to the matched sample image when the input facial image matches with any selected sample image; the step f3) is performed to select the human identity data corresponding to the matched sample voiceprint when the input voiceprint matches with any selected sample voiceprint; the method further comprises a step g) configuring the same human identity data as the identity of the human when any human identity data selected in the step e) is duplicate with any human identity data selected in the step f3).

11. A human recognition method based on data fusion, the method being applied to a human recognition system, the human recognition system comprising an image capture device and a voice-sensing device, the method comprising following steps:
a) shooting a face of a human by the image capture device for obtaining an input facial image;
b) selecting a part of a plurality of sample voice features according to the input facial image;
c) sensing voice of the human by the voice-sensing device for generating an input voice;
d) analyzing the input voice for obtaining an input voice feature; and
e) comparing the input voice feature with the selected part of the sample voice features for recognizing the human.

12. The human recognition method based on data fusion according to claim 11, wherein the sample voice features correspond to a plurality of human identity data respectively; each sample voice feature comprises a sample text; the step d) is performed to analyze the input voice for obtaining an input text; the step e) is performed to configure the human identity data corresponding to the matched sample text as an identity of the human when the input text matches with any of the select part of the sample texts.

13. The human recognition method based on data fusion according to claim 11, wherein the sample voice features correspond to a plurality of human identity data respectively; each sample voice feature comprises a sample voiceprint; the step d) is performed to analyze the input voice for obtaining an input voiceprint; the step e) is performed to configure the human identity data corresponding to the matched sample voiceprint as an identity of the human when the input voiceprint matches with any of the select part of the sample voiceprints.

14. The human recognition method based on data fusion according to claim 11, wherein the sample voice features correspond to a plurality of human identity data respectively; each sample voice feature comprises a sample text and a sample voiceprint; the step d) is performed to analyze the input voice for obtaining an input text and an input voiceprint; the step e) is performed to configure the human identity data corresponding to both the matched sample text and the matched sample voiceprint as an identity of the human when the input text matches with any of the select part of the sample texts and the input voiceprint matches with any of the select part of the sample voiceprints.

15. The human recognition method based on data fusion according to claim 11, wherein the step d) is performed to analyze the input voice for obtaining the input voice feature when a volume of the sensed voice is greater than a volume threshold.

16. The human recognition method based on data fusion according to claim 11, wherein the step b) comprises following steps:
b1) comparing the input facial image with a plurality of sample images, wherein the sample images respectively correspond to the sample voice features; and
b2) when the input facial image matches with any sample image, selecting the sample voice feature corresponding to the matched sample image.

17. The human recognition method based on data fusion according to claim 16, wherein the image capture device comprises a color image capture device and an infrared image capture device; each sample image comprises a color sample image and an infrared sample image; the step a) comprises following steps:
a1) capturing the face of the human by the color image capture device for obtaining a color facial image; and
a2) capturing the face of the human by the infrared image capture device for obtaining an infrared facial image;
the step b1) is performed to compare the color facial image with the selected part of the color sample images, and compare the infrared facial image with the selected part of the infrared sample images.

18. The human recognition method based on data fusion according to claim 17, wherein the step b1) comprises following steps:
b11) comparing the color facial image with each color sample image for determining a color similarity between the color facial image and each color sample image;
b12) comparing the infrared facial image with each infrared sample image for determining an infrared similarity between the infrared facial image and each infrared sample image; and
b13) computing a similarity to each sample image according to the color similarity and the infrared similarity to each sample image;
the step b2) is performed to determine that the input facial image matches with the sample image when any similarity to the sample image is not less than a similarity threshold.

19. The human recognition method based on data fusion according to claim 16, wherein each human identity data corresponds to the sample images respectively; the step b1) performed to compare the input facial image with the sample images for computing a similarity between the input facial image and each sample image; the step b2) is performed to determine that the input facial image matches with the sample image when any similarity to the sample image is not less than a similarity threshold;
wherein the step b) further comprises a step b3) the step a) is performed when the similarities to all of the sample images are less than the similarity threshold.

20. The human recognition method based on data fusion according to claim 19, wherein the step a) is performed to obtain the input facial images of the same human; the step b2) is performed to compare the input facial images with the sample images individually for determining the similarity between each input facial image and each sample image.
